(19) United States
(12) Patent Application Publication
(10) Pub. No.: US 2026/0100527 A1
(43) Pub. Date: Apr. 9, 2026

(54) ELECTRICAL CONNECTION UNIT

(71) Applicant: YAZAKI CORPORATION, Tokyo (JP)

(72) Inventors: Ryu Senoo, Kakegawa-shi, Shizuoka (JP); Hirotaka Mukasa, Kakegawa-shi, Shizuoka (JP); Kazuhiko Tsuchiya, Kakegawa-shi, Shizuoka (JP)

(21) Appl. No.: 19/349,914

(22) Filed: Oct. 3, 2025

(30) Foreign Application Priority Data
Oct. 7, 2024 (JP) 2024-175936

(51) Int. Cl. H01R 9/28; H01R 9/22; H01R 9/24

(52) U.S. Cl. CPC H01R 9/28; H01R 9/226; H01R 9/2466

(57) ABSTRACT

An electrical connection unit includes a bus bar and a base member. The base member has an accommodation portion in which at least a part of the bus bar is accommodated, and has an insulating property. The electrical connection unit is provided with a holding structure. The holding structure includes at least either of a plurality of protrusions protruding from an inner surface of the accommodation portion toward the bus bar and a plurality of protrusions protruding from a surface of the bus bar toward the inner surface of the accommodation portion. The holding structure holds the bus bar with respect to the accommodation portion in a state in which a gap is formed between the inner surface of the accommodation portion and the bus bar.

### BACKGROUND OF THE INVENTION

### Field of the Invention

Embodiments of the present invention relate to an electrical connection unit. Priority is claimed on Japanese Patent Application No. 2024-175936 filed in Japan on Oct. 7, 2024, the content of which is incorporated herein by reference.

### Description of Related Art

An electrical connection unit having an electronic component and a bus bar electrically connected to the electronic component is known.

### PRIOR ART DOCUMENT

### Patent Document

Patent Document 1: Japanese Unexamined Patent Application, First Publication No. 2024-037492

### SUMMARY OF THE INVENTION

Incidentally, the electrical connection unit is expected to have improved durability.

An embodiment provides an electrical connection unit capable of improving durability.

An electrical connection unit of an embodiment includes a bus bar and a base member. The base member has an accommodation portion in which at least a part of the bus bar is accommodated, and has an insulating property. The electrical connection unit is provided with a holding structure. The holding structure includes at least either of a plurality of protrusions protruding from an inner surface of the accommodation portion toward the bus bar and a plurality of protrusions protruding from a surface of the bus bar toward the inner surface of the accommodation portion. The holding structure holds the bus bar with respect to the accommodation portion in a state in which a gap is formed between the inner surface of the accommodation portion and the bus bar.

According to one embodiment, durability can be improved.

### BRIEF DESCRIPTION OF THE DRAWINGS

FIG. 1 is a cross-sectional view illustrating an electrical connection unit of an embodiment;

FIG. 2 is a perspective view showing a main body of the embodiment;

FIG. 3 is a perspective view showing one subunit of the embodiment;

FIG. 4 is a perspective view illustrating an electronic component and a connection component of the embodiment;

FIG. 5 is a perspective view showing a routing board of the embodiment;

FIG. 6 is a partially exploded perspective view of the routing board of the embodiment;

FIG. 7 is a plan view illustrating a subunit of the embodiment;

FIG. 8 is a plan view illustrating the routing board of the embodiment;

FIG. 9 is a plan view illustrating a base plate of the embodiment;

FIG. 10 is a perspective view showing a holding structure of the embodiment;

FIG. 11 is a cross-sectional view taken along line F11-F11 of a structure illustrated in FIG. 7;

FIG. 12 is a cross-sectional view taken along line F12-F12 of the structure illustrated in FIG. 7;

FIG. 13 is a plan view illustrating a routing board of a first modification example of the embodiment;

FIG. 14 is a plan view illustrating a routing board of a second modification example of the embodiment;

FIG. 15 is a cross-sectional view illustrating a subunit of a third modification example of the embodiment;

FIG. 16 is a cross-sectional view illustrating a subunit of a fourth modification example of the embodiment;

FIG. 17 is a plan view illustrating a routing board of a fifth modification example of the embodiment; and

FIG. 18 is a plan view illustrating a routing board of a sixth modification example of the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively.

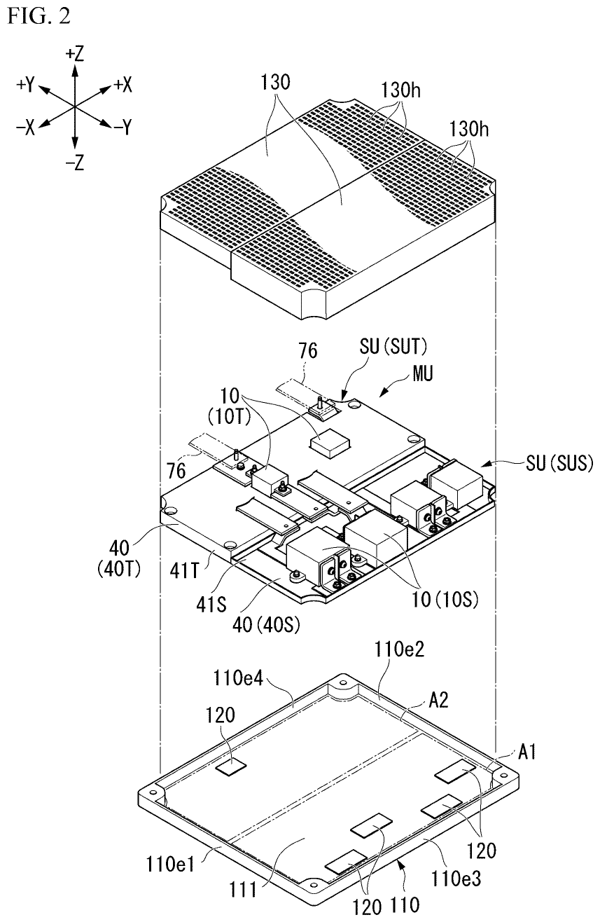

In the present disclosure, a +X direction, a −X direction, a +Y direction, a −Y direction, a +Z direction, and a −Z direction are defined as follows. The +X direction is a direction from a first end 110e1 to a second end 110e2 of a metal plate 110 that will be described later (see FIG. 2). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 110e3 to a fourth end 110e4 of the metal plate 110 that will be described later (see FIG. 2). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from the metal plate 110 that will be described later toward a main body MU (see FIG. 2). The −Z direction is a direction opposite to the +Z direction. Hereinafter, in a case where the +Z direction and the −Z direction are not distinguished, the directions will be simply referred to as “Z direction”. The Z direction is an example of a “first direction”. The X direction is an example of a “second direction”. The Y direction is an example of a “third direction”. Note that the Y direction may correspond to another example of the “second direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### EMBODIMENT

### 1. Constitution of Electrical Connection Unit

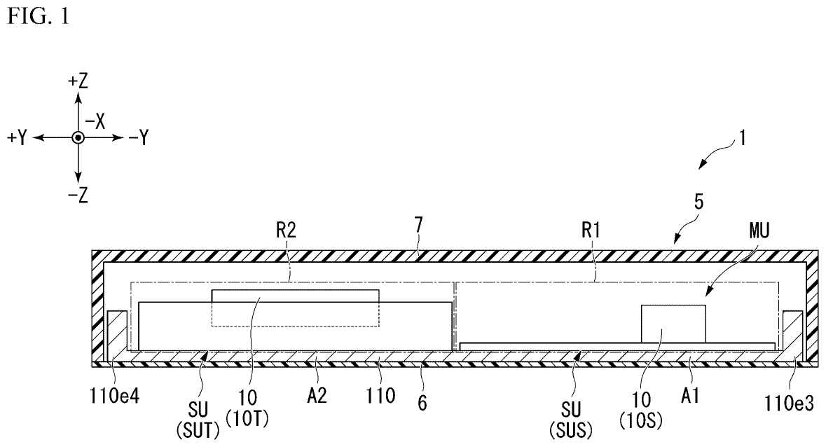

FIG. 1 is a cross-sectional view illustrating an electrical connection unit 1 of an embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 includes, for example, a casing 5, a main body MU, a metal plate 110, a plurality of heat transfer members 120 (see FIG. 2), and a plurality of insulating covers 130 (see FIG. 2).

### 2. Casing

First, the casing 5 will be described. The casing 5 forms an outline of the electrical connection unit 1. The casing 5 includes, for example, a base 6 (first member) and a cover 7 (second member). The base 6 is a member that covers the main body MU and the metal plate 110 from below. The base 6 has, for example, a plate shape formed in the horizontal direction or a bowl shape open in the +Z direction. The base 6 is made of, for example, a synthetic resin. The cover 7 is a member that covers the main body MU and the metal plate 110 from above. The base 6 has, for example, a bowl shape open in the −Z direction. The cover 7 is made of, for example, a synthetic resin. In the present embodiment, the box-shaped casing 5 is formed by combining the base 6 and the cover 7. The shape of the casing 5 is not limited to the above example. For example, the metal plate 110 that will be described later may function as a part or the whole of the base 6. The casing 5 may be omitted.

In the present embodiment, the electrical connection unit 1 includes a first region (first space) R1 and a second region (second space) R2. The first region R1 is a region in which a heat dissipation property is emphasized. In the first region R1, for example, an electronic component 10S having a great amount of heat generation is disposed. On the other hand, the second region R2 is a region in which a mountability is emphasized. In the second region R2, for example, an electronic component 10T that has a smaller amount of heat generation than the electronic component 10S and/or requires a more complicated mounting structure than the electronic component 10S is disposed. However, these contents do not limit the contents of the electrical connection unit 1 of the present disclosure. For example, the amount of heat generation of the electronic component 10T may be greater than the amount of heat generation of the electronic component 10S.

### 3. Main Body

Next, the main body MU will be described.

FIG. 2 is a perspective view showing the main body MU. The main body MU is a portion that performs a main function (for example, switching of electrical connection states or overcurrent protection) of the electrical connection unit 1. In the present embodiment, the main body MU is divided into a plurality of subunits SU. The main body MU is formed by connecting the plurality of subunits SU, for example. In the present embodiment, the main body MU includes two subunits SU (subunits SUS and SUT). Each subunit SU may be referred to as a “circuit constitution body”.

The subunit SUS has an electrical first function. The subunit SUS includes, for example, a plurality of electronic components 10S and a routing board 40S. The plurality of electronic components 10S are electrically connected to the routing board 40S.

The subunit SUT has an electrical second function. The second function is a function different from the first function. The subunit SUT includes, for example, a plurality of electronic components 10T and a routing structure 40T. The plurality of electronic components 10T are electrically connected to the routing structure 40T.

In the present embodiment, the subunit SUS is a subunit SU in which a heat dissipation property is emphasized. The subunit SUS is disposed in the above first region R1 of the electrical connection unit 1. The subunit SUS faces a first region A1 of the metal plate 110 that will be described later in the Z direction.

On the other hand, the subunit SUT is a subunit SU in which moutability is emphasized. The subunit SUT is disposed, for example, on the +Y direction side with respect to the subunit SUS. The subunit SUT is disposed in the above second region R2 of the electrical connection unit 1. The subunit SUT faces a second region A2 of the metal plate 110 that will be described later in the Z direction. Hereinafter, in a case where the electronic component 10S and the electronic component 10T are not distinguished, the electronic components are simply referred to as “electronic component 10”.

Note that the main body MU need not be divided into a plurality of subunits SU instead of the example described above. For example, the plurality of subunits SU may be integrally formed. For example, a base plate 41S of the routing board 40S and a base member 41T of the routing structure 40T, which will be described later, may be integrally formed by one piece member.

### 4. Constitution of Subunit SUS

Next, a constitution of the subunit SUS will be described.

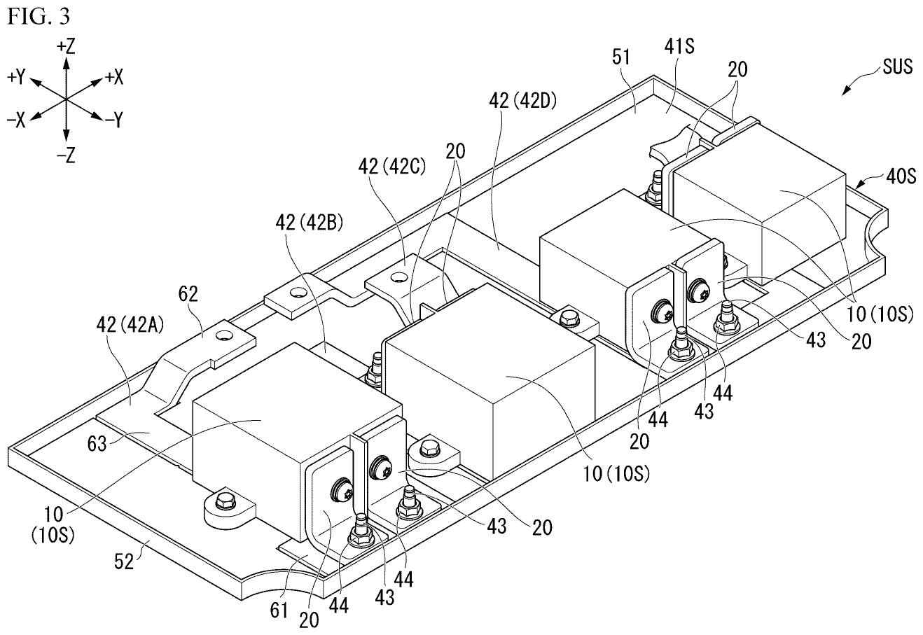

FIG. 3 is a perspective view showing the subunit SUS. The subunit SUS includes, for example, a plurality of electronic components 10, a plurality of connection components 20, and a routing board 40S. The connection component 20 is a member forming an energization path in the vertical direction. The connection component 20 may be referred to as a “vertical routing member”.

### 4.1 Electronic Component

First, the electronic component 10 will be described. The electronic component 10 is an electronic component mounted according to a function required for each subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. However, the type of the electronic component 10 is not limited to the above example. The electronic component 10 is, for example, a heat generating component that generates heat at the time of energization.

In the present embodiment, the plurality of electronic components 10 include an electronic component 10S that generates relatively large heat when energized. The electronic component 10S is a relay (for example, a mechanical relay or a semiconductor relay), a pyrofuse, a current sensor (for example, a current sensor having a shunt resistor), or the like. However, the type of the electronic component 10S is not limited to the above example.

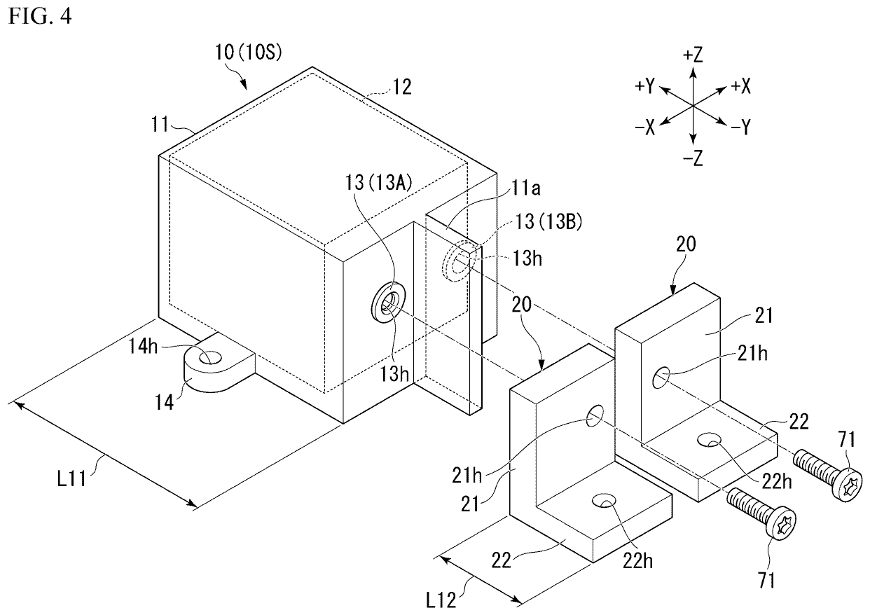

FIG. 4 is a perspective view illustrating the electronic component 10 and the connection component 20. The electronic component 10 is, for example, an electronic component in which a plurality of terminals 13 are disposed to be arranged at one end of the electronic component 10S. The electronic component 10 includes, for example, a case 11, a component body 12, a plurality of terminals 13, and a plurality of attachment portions 14.

### Case

The case 11 is an outer member that forms most of the outer shape of the electronic component 10. The case 11 is made of, for example, synthetic resin and has an insulating property. The case 11 accommodates the component body 12. The case 11 and the component body 12 may be integrally formed.

In the present embodiment, the case 11 has an insulating rib 11a protruding in the horizontal direction (for example, the Y direction) and extending in the Z direction. The insulating rib 11a has, for example, a plate shape formed in the horizontal direction (for example, the Y direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, a part of the insulating rib 11a is disposed between the first portions 21 (that will be described later) of the two connection components 20 connected to the electronic component 10. The insulating rib 11a electrically insulates between the first portions 21 of the two connection components 20 connected to the electronic component 10.

### Component Body

The component body 12 is a portion that performs a main function of the electronic component 10. For example, in a case where the electronic component 10 is a relay, the component body 12 includes a switch (for example, a contact) that switches between a conductive state and a non-conductive state. For example, in a case where the electronic component 10 is a fuse, the component body 12 includes a fusion portion that is fused when an overcurrent flows. For example, in a case where the electronic component 10 is a capacitor, the component body 12 includes a portion that stores electric charge.

### Terminal

The terminal 13 is an electrical connection portion exposed to the outside of the case 11. The terminal 13 is electrically connected to the component body 12 inside the case 11. In the present embodiment, the electronic component 10 includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one end of the electronic component 10 in the horizontal direction (for example, the Y direction). The terminal 13A and the terminal 13B are disposed to be arranged in the horizontal direction (for example, the X direction). Each of the terminal 13A and the terminal 13B is directed in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the Y direction). An inner circumferential surface of the attachment hole 13h of the electronic component 10 has a screw groove.

### Attachment Portion

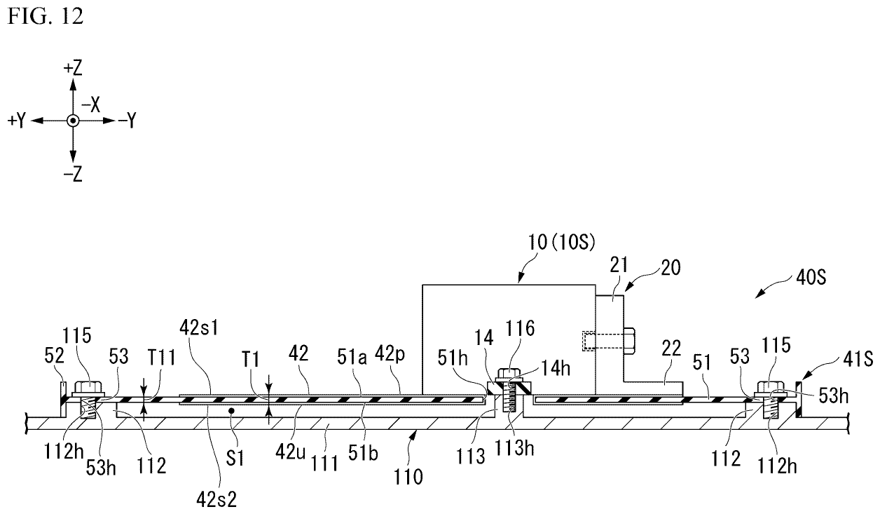

The attachment portion 14 is a portion for fixing the electronic component 10. The attachment portion 14 has an attachment hole 14h to which a fastening member 116 (for example, a screw or a bolt; and see FIG. 12) that will be described later is attached. The attachment hole 14h is open in the Z direction. The attachment hole 14h is an insertion hole through which the fastening member 116 passes. A fixing destination of the attachment portion 14 will be described later.

### 4.2 Connection Component

Next, the connection component 20 will be described. The connection component 20 is a component that electrically connects the electronic component 10 to the routing board 40S. The connection component 20 forms a part of an energization path in the subunit SUS. The connection component 20 is made of metal (for example, made of copper, made of a copper alloy, made of aluminum, or made of an aluminum alloy). The connection component 20 may be referred to as a “metal component”.

In the present embodiment, the connection component 20 electrically connects the electronic component 10 to the bus bar 42 (see FIG. 3) included in the routing board 40S. In the present embodiment, a length L12 of the connection component 20 in the longitudinal direction (for example, the Y direction) of the electronic component 10 is smaller than a length L11 of the electronic component 10 in the longitudinal direction. The connection component 20 includes, for example, a first portion 21 and a second portion 22.

### First Portion

The first portion 21 of the connection component 20 is a portion connected to the terminal 13 of the electronic component 10. The first portion 21 is a plate-shaped or rectangular parallelepiped portion extending in the Z direction. The first portion 21 extends in the Z direction along one end (for example, an end in the Y direction) of the electronic component 10. The first portion 21 is a standing portion that stands in the Z direction with respect to the routing board 40S (for example, with respect to a bus bar 42 that will be described later). The first portion 21 is adjacent to the electronic component 10 in the horizontal direction (for example, the Y direction). For example, the first portion 21 is adjacent to the terminal 13 of the electronic component 10 in the horizontal direction (for example, the Y direction), and is connected to the terminal 13 of the electronic component 10 from the horizontal direction (for example, the Y direction).

The first portion 21 of the connection component 20 has a first attachment hole 21h through which the fastening member 71 (for example, a screw or a bolt) passes. The first attachment hole 21h is open in the horizontal direction (for example, the Y direction). The fastening member 71 that has passed through the first attachment hole 21h is engaged with the attachment hole 13h of the terminal 13 of the electronic component 10, and thus the first portion 21 is physically and electrically connected to the terminal 13 of the electronic component 10.

### Second Portion

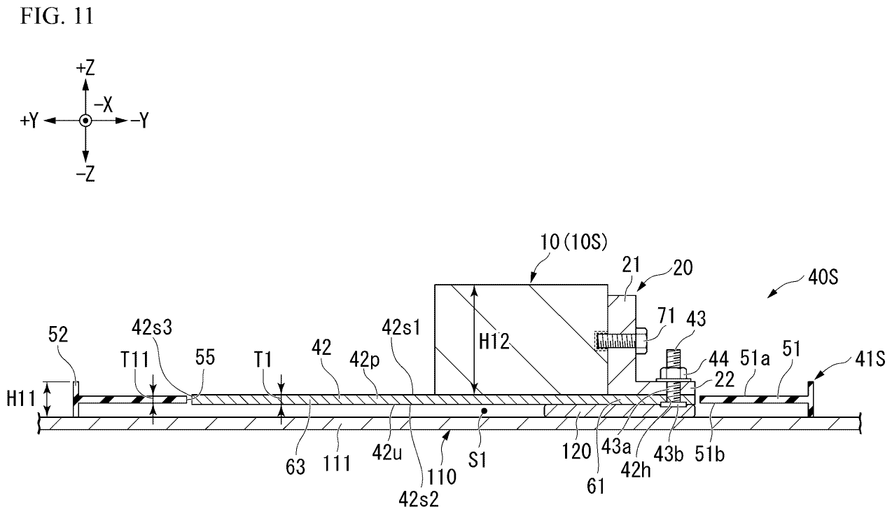

The second portion 22 of the connection component 20 is a portion connected to the bus bar 42 (see FIG. 3). The second portion 22 protrudes in the horizontal direction (for example, the Y direction) from the end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20 is attached to the fastening member 43 (for example, a screw or a bolt; and see FIG. 11) protruding from the bus bar 42 in the +Z direction from the Z direction, and is physically and electrically connected to the bus bar 42. In the present embodiment, the second portion 22 of the connection component 20 has a second attachment hole 22h through which the fastening member 43 passes. The second attachment hole 22h is open in the Z direction. In the second portion 22, the fastening member 43 passes through the second attachment hole 22h. The engagement member 44 (for example, a nut; and see FIG. 11) is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20.

In the present embodiment, the bus bar 42 is disposed at a position away from the terminal 13 of the electronic component 10 (for example, a position away in the Z direction). The connection component 20 is disposed between the electronic component 10 and the bus bar 42. In the present disclosure, the phrase “the connection component is disposed between the electronic component and the bus bar” is not limited to a case where a part of the connection component is located between the electronic component and the bus bar when viewed from the X direction or the Y direction. The phrase “the connection component is disposed between the electronic component and the bus bar” may correspond to a case where a part of the connection component is located between the electronic component and the bus bar when viewed from a direction inclined with respect to the X direction or the Y direction. The connection component 20 electrically connects the terminal 13 of the electronic component 10 to the bus bar 42.

### 4.3 Routing Board

Next, the routing board 40S will be described.

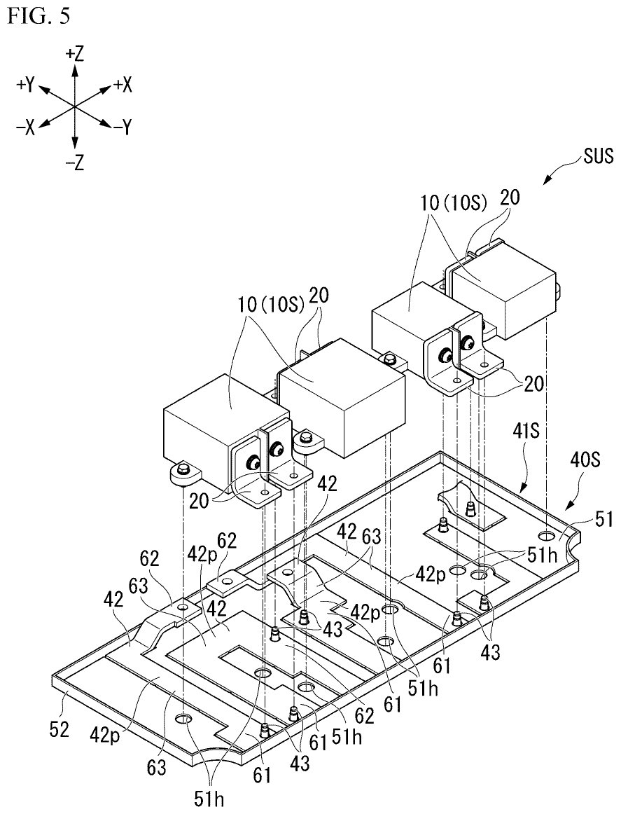

FIG. 5 is a perspective view showing the routing board 40S. The routing board 40S is a member that forms at least a part of an energization path between a plurality of electronic components 10 (for example, a plurality of electronic components 10S) and/or at least a part of an energization path between the electronic component 10 (for example, the electronic component 10S) included in the subunit SUS and the electronic component 10 included in another subunit SU (for example, the subunit SUT). In the present disclosure, the “routing board” indicates a board-type routing structure. The “board type” indicates a plate shape along one plane when viewed as a whole regardless of a fine shape. In the present disclosure, the term “plate shape”, “sheet shape”, or “planar” is not limited to the case of being completely flat, and may include a case where a fixing structure, a rib, or the like protruding in the Z direction is partially present, a case where an uneven shape following the thickness of the bus bar is present on the surface, and the like. In the present embodiment, the routing board 40S has a plate shape formed in the X direction and the Y direction.

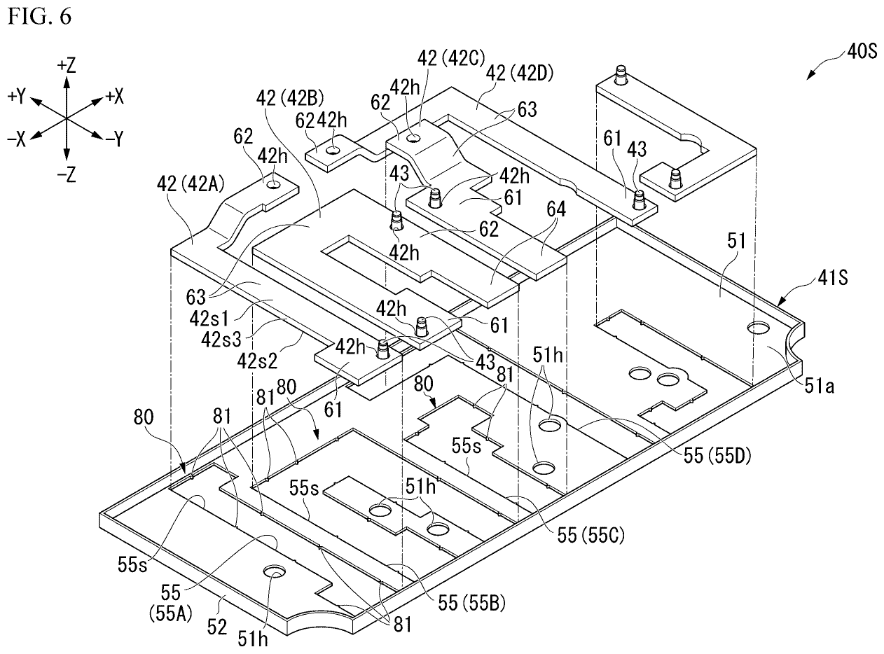

The routing board 40S includes, for example, a base plate 41S, one or more (for example, a plurality of) bus bars 42, and a plurality of fastening members 43. In the present embodiment, each bus bar 42 is held on the base plate 41S by a holding structure 80 (see FIG. 6) provided on the base plate 41S. For example, the routing board 40S is integrated with the base plate 41S by holding the bus bar 42 by the holding structure 80 after the fastening member 43 is fixed to the bus bar 42. That is, the bus bar 42 is integrated with the base plate 41S without using a fastening member such as a screw or a bolt. The holding structure 80 will be described later in detail.

FIG. 6 is a partially exploded perspective view illustrating the routing board 40S. Hereinafter, for convenience of description, the base plate 41S, the bus bar 42, and the fastening member 43 will be described with reference to the drawings in which the routing board 40S is partially exploded.

### 4.3.1 Base Plate

The base plate 41S is a support member that integrally supports the plurality of bus bars 42 arranged at intervals in the horizontal direction. The base plate 41S is made of, for example, a synthetic resin and has an insulating property. The base plate 41S electrically insulates the plurality of bus bars 42 from each other. The base plate 41S is an example of a “base member”. The base plate 41S may be referred to as an “insulating substrate”. The base plate 41S includes, for example, a flat surface portion 51, a frame portion 52, and a plurality of fixing portions 53 (see FIG. 12).

### Flat Surface Portion

The flat surface portion 51 is a portion formed in a plate shape in the base plate 41S. The flat surface portion 51 has a plate shape formed in the horizontal direction. The flat surface portion 51 forms a main portion of the base plate 41S. The flat surface portion 51 forms a base portion (insulating base portion) of the base plate 41S. In the present embodiment, the flat surface portion 51 extends over the entire width in the X direction of the base plate 41S and over the entire width in the Y direction of the base plate 41S except for the frame portion 52 of the base plate 41S.

The flat surface portion 51 has a first surface 51a and a second surface 51b (see FIG. 11). The first surface 51a is a surface directed in the +Z direction. The first surface 51a is a flat surface provided in the horizontal direction. The first surface 51a faces the plurality of electronic components 10 (for example, the plurality of electronic components 10S). The second surface 51b is located on the side opposite to the first surface 51a. The second surface 51b is a surface directed in the −Z direction. The second surface 51b is a flat surface provided in the horizontal direction. The second surface 51b faces the metal plate 110 (see FIG. 2). A thickness direction (plate thickness direction) of the flat surface portion 51 is the Z direction. In the present embodiment, a thickness T11 of the flat surface portion 51 in the Z direction is smaller than a thickness T1 of the bus bar 42 in the Z direction (for example, a thickness of a horizontal plate portion 42p that will be described later in the Z direction) (see FIG. 12). The thickness T11 of the flat surface portion 51 in the Z direction may be equal to the thickness T1 of the bus bar 42 in the Z direction, or may be larger than the thickness T1 of the bus bar 42 in the Z direction.

The flat surface portion 51 has, for example, one or more (for example, a plurality of) accommodation portions 55 in which the bus bars 42 are accommodated, respectively. The plurality of accommodation portions 55 are formed apart from each other in the X direction or the Y direction. Each of the accommodation portions 55 is, for example, a through-hole penetrating the flat surface portion 51 in the Z direction. Note that the accommodation portion 55 may be a recess provided on the first surface 51a or the second surface 51b of the flat surface portion 51 and recessed in the Z direction, instead of a through-hole. In the present disclosure, the phrase “the accommodation portion penetrates the flat surface portion in the first direction (Z direction)” may include a case where a part of the entire length of the accommodation portion 55 penetrates the flat surface portion 51 in the Z direction (for example, the remaining portion of the accommodation portion 55 may be a recess recessed in the Z direction, or may be provided inside the base plate 41S and not exposed to the outside of the base plate 41S). Similarly, in the present disclosure, the phrase “the accommodation portion is recessed in the first direction (Z direction)” may include a case where a part of the entire length of the accommodation portion 55 is recessed in the Z direction (for example, a remaining portion of the accommodation portion 55 may be a through-hole penetrating the flat surface portion 51 in the Z direction, or may be provided inside the base plate 41S and not exposed to the outside of the base plate 41S).

Each accommodation portion 55 has an outer shape corresponding to the shape of the bus bar 42 to be accommodated when viewed from the Z direction. The accommodation portion 55 has an inner surface 55s facing the bus bar 42. The inner surface 55s extends in the Z direction over the first surface 51a and the second surface 51b of the flat surface portion 51, and couples the first surface 51a and the second surface 51b of the flat surface portion 51. The inner surface 55s extends along the shape of the bus bar 42 to surround the bus bar 42 when viewed from the Z direction.

The plurality of the accommodation portions 55 include, for example, four accommodation portions 55A, 55B, 55C, and 55D. The accommodation portion 55A is provided to correspond to a bus bar 42A that will be described later, and accommodates at least a part of the bus bar 42A. The accommodation portion 55B is provided to correspond to a bus bar 42B that will be described later, and accommodates at least a part of the bus bar 42B. The accommodation portion 55C is provided to correspond to a bus bar 42C that will be described later, and accommodates at least a part of the bus bar 42C. The accommodation portion 55D is provided to correspond to a bus bar 42D that will be described later, and accommodates at least a part of the bus bar 42D.

### Frame Portion

The frame portion 52 is provided at a peripheral end of the base plate 41S. The frame portion 52 is a reinforcement rib protruding vertically from the end of the flat surface portion 51 (see FIG. 11). A width (thickness) H11 of the frame portion 52 in the Z direction is, for example, less than half of a width (thickness) H12 of the electronic component 10 in the Z direction (see FIG. 11). Note that the frame portion 52 may be omitted.

### Fixing Portion

The fixing portion 53 is a portion fixed to the metal plate 110 (see FIG. 12). The fixing portion 53 has an attachment hole 53h penetrating the base plate 41S in the Z direction. A fastening member 115 (for example, a screw or a bolt) that will be described later passes through the attachment hole 53h. This content will be described later.

### 4.3.2 Bus Bar

The bus bar 42 is a routing member (electrical connection member) included in the routing board 40S. The bus bar 42 is, for example, a routing member for electrically connecting a plurality of electronic components (for example, a plurality of electronic components 10S). Alternatively, the bus bar 42 may be a routing member for electrically connecting the electronic component 10 (for example, the electronic component 10S) to the electronic component 10 included in another subunit SU (for example, the subunit SUT). The bus bar 42 is made of metal (for example, made of copper, made of a copper alloy, made of aluminum, or made of an aluminum alloy) and has conductivity. In the present embodiment, a plurality of bus bars 42, for example, four bus bars 42A, 42B, 42C, and 42D are included. The four bus bars 42A, 42B, 42C, and 42D are disposed to be arranged at intervals in the horizontal direction. The four bus bars 42A, 42B, 42C, and 42D include portions disposed on the same plane. The four bus bars 42A, 42B, 42C, and 42D are supported by the flat surface portion 51 of the base plate 41S. In the present disclosure, the phrase “the bus bar is supported by the flat surface portion” is not limited to the case where the bus bar 42 is accommodated in the accommodation portion 55, and may include a case where the bus bar 42 is attached to the first surface 51a or the second surface 51b of the flat surface portion 51.

At least a part of each bus bar 42 has a plate shape formed in the horizontal direction. At least a part of each bus bar 42 is accommodated in the accommodation portion 55 and extends along the flat surface portion 51. That is, at least a part of each bus bar 42 extends along the first surface 51a of the flat surface portion 51. At least a part of each bus bar 42 extends in the horizontal direction in the accommodation portion 55. Hereinafter, a portion of each bus bar 42 that is accommodated in the accommodation portion 55 and extends in a plate shape along the flat surface portion 51 may be referred to as a “horizontal plate portion 42p”. The horizontal plate portion 42p is an example of a “plate portion”. The bus bar 42 is a member that forms a horizontal energization path. The bus bar 42 may be referred to as a “horizontal routing member”.

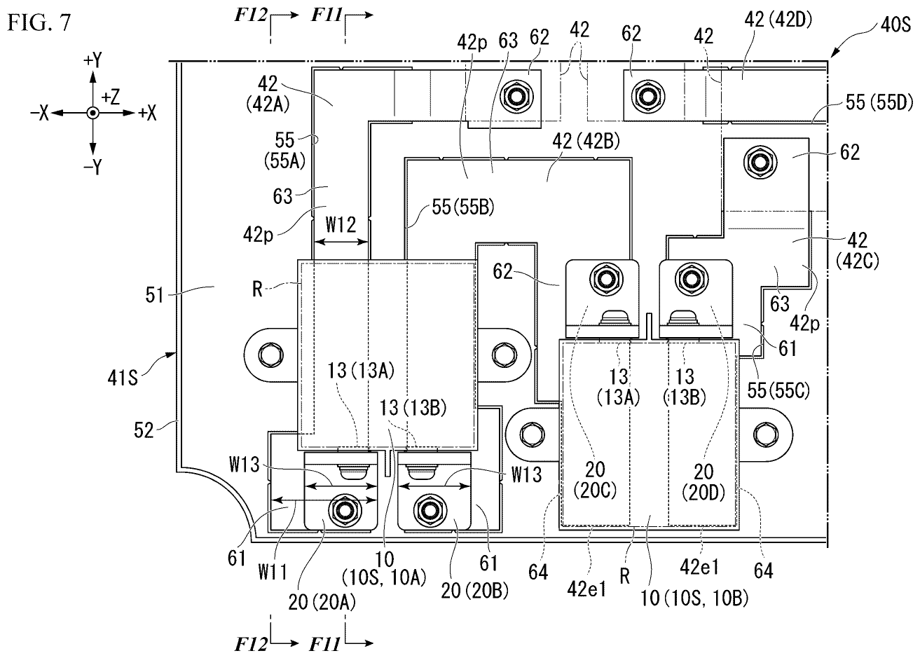

FIG. 7 is a plan view illustrating the subunit SUS. Each bus bar 42 includes, for example, a connection portion 61, a connection portion 62, and an extending portion 63.

The connection portion 61 is located in the middle of the bus bar 42 or at the first end of the bus bar 42. The connection portion 61 is a portion connected to the electronic component 10 (for example, the electronic component 10S) directly or via the connection component 20. The connection portion 61 includes, for example, a portion overlapping the connection component 20 when viewed from the Z direction. The connection portion 61 is adjacent to the connection component 20 in the Z direction and is connected to the connection component 20 from the Z direction. Instead of the above example, for example, the connection portion 61 may be adjacent to the terminal 13 of the electronic component 10 in the Z direction and directly connected to the terminal 13 of the electronic component 10 from the Z direction.

The connection portion 62 is located in the middle of the bus bar 42 or at the second end of the bus bar 42. The connection portion 62 is a portion connected to another electronic component 10 directly or via another connection component 20. Instead of the above example, the connection portion 62 may be connected to another bus bar 42(for example, the bus bar 42 included in another subunit SU) or an external connection bus bar 76 (see FIG. 2).

The extending portion 63 extends from the connection portion 61 in the X direction or the Y direction. The extending portion 63 is provided between the connection portion 61 and the connection portion 62. The extending portion 63 extends over the connection portion 61 and the connection portion 62. The extending portion 63 connects the connection portion 61 to the connection portion 62.

In the present embodiment, the horizontal plate portion 42p described above includes at least the entire connection portion 61 and a part of the extending portion 63. That is, at least the entire connection portion 61 and a part of the extending portion 63 are accommodated in the accommodation portion 55 and located on the same plane.

In the present embodiment, the extending portions 63 of some of the bus bars 42 are accommodated in the accommodation portion 55 to extend over both sides of a region R through the region R overlapping the electronic component 10 when viewed from the Z direction. For example, the extending portion 63 extends over the region R overlapping the electronic component 10 when viewed from the Z direction, over the −Y direction side and the +Y direction side of the region R. That is, the bus bar 42 is accommodated in the accommodation portion 55 to be easily routed through a better path (for example, a path with a shorter distance) without being disturbed by the presence of the electronic component 10.

One or more bus bars 42 may have an extension 64 in addition to the connection portion 61, the connection portion 62, and the extending portion 63. The extension 64 is a portion where the bus bar 42 extends for the purpose of increasing a heat dissipation area and/or increasing a heat capacity for heat storage (heat absorption). The extension 64 is a portion that is not used for electrical connection. For example, the extension 64 is located on the side opposite to the extending portion 63 with respect to the connection portion 61 (or the connection portion 62). The extension 64 has a plate shape formed in the horizontal direction. The extension 64 is included in the horizontal plate portion 42p. The extension 64 is accommodated in the accommodation portion 55 and extends along the flat surface portion 51. The extension 64 extends to the region R overlapping the electronic component 10 when viewed from the Z direction, and has an end 42e1 of the bus bar 42 at a position overlapping the electronic component 10 when viewed from the Z direction.

Some routing examples of the bus bar 42 will be described below. Note that the plurality of electronic components 10S include, for example, two electronic components 10A and 10B. The plurality of connection components 20 include, for example, four connection components 20A, 20B, 20C, and 20D.

The bus bar 42A has the connection portion 61, the connection portion 62, and the extending portion 63. The connection portion 61 is connected to the terminal 13A of the electronic component 10A via the connection component 20A. The connection portion 62 is disposed at the end of the subunit SUS on the +Y direction side and is connected to the bus bar 42 included in another subunit SU. The extending portion 63 is accommodated in the accommodation portion 55 to extend over both sides of the region R through the region R overlapping the electronic component 10A when viewed from the Z direction.

The bus bar 42B has the connection portion 61, the connection portion 62, the extending portion 63, and the extension 64. The connection portion 61 is connected to the terminal 13B of the electronic component 10A via the connection component 20B. The connection portion 62 is connected to the terminal 13A of the electronic component 10B via the connection component 20C. The extension 64 extends to the region R overlapping the electronic component 10B when viewed from the Z direction, and has an end 42e1 of the bus bar 42 at a position overlapping the electronic component 10B.

The bus bar 42C has the connection portion 61, the connection portion 62, and the extending portion 63. The connection portion 61 is connected to the terminal 13B of the electronic component 10B via the connection component 20D. The connection portion 62 is disposed at the end of the subunit SUS on the +Y direction side and is connected to the bus bar 42 included in another subunit SU.

### Exposure Structure on Upper Surface Side of Each Bus Bar

In the present embodiment, at least a part of the bus bar 42 is exposed to the upper surface side of the base plate 41S. For example, the connection portion 61, the connection portion 62, and the extending portion 63 of the bus bar 42 are exposed to the outside of the base plate 41S on the upper surface side (the first surface 51a side of the flat surface portion 51) of the base plate 41S. For example, the extending portion 63 of the bus bar 42 is exposed to the outside of the base plate 41S on the upper surface side of the base plate 41S at least over the entire length between the connection portion 61 and the connection portion 62.

### Exposure Structure on Lower Surface Side of Each Bus Bar

In the present embodiment, at least a part of the bus bar 42 is exposed to the lower surface side of the base plate 41S. For example, the entire connection portion 61 and at least a part of the extending portion 63 are exposed to the outside of the base plate 41S on the lower surface side of the base plate 41S (the second surface 51b side of the flat surface portion 51). In the present embodiment, a gap S1 is formed between the flat surface portion 51 of the base plate 41S and the metal plate 110 (see FIG. 11). The bus bar 42 includes an exposed portion 42u exposed to the gap S1 (see FIG. 11). The exposed portion 42u includes, for example, the entire connection portion 61 and at least a part of extending portion 63.

### Surface Shape of Each Bus Bar

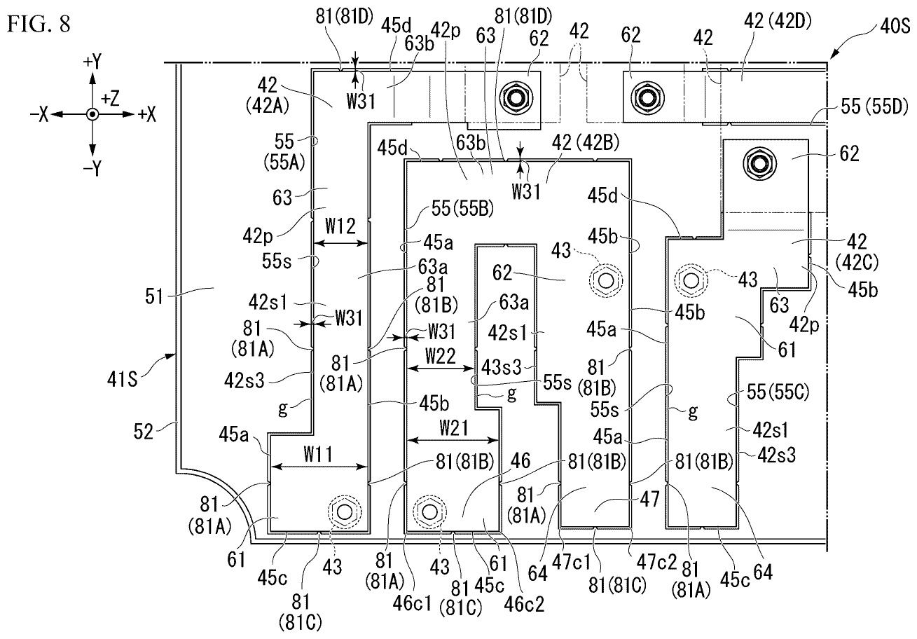

FIG. 8 is a plan view illustrating the routing board 40S. Each bus bar 42 (for example, the horizontal plate portion 42p of each bus bar 42) has a first main surface 42s1, a second main surface 42 s2 (see FIG. 11), and a side surface 42s3.

The first main surface 42s1 is a surface of the bus bar 42 directed in the +Z direction. The first main surface 42s1 is, for example, a flat surface provided in the horizontal direction. The first main surface 42s1 has a larger area than the side surface 42s3. For example, the first main surface 42s1 is exposed to the outside of the base plate 41S on the upper surface side (the first surface 51a side of the flat surface portion 51) of the base plate 41S (see FIG. 11). The first main surface 42s1 faces the electronic component 10 (for example, the electronic component 10S) and the connection component 20. In the present embodiment, the first main surface 42s1 is in contact with the second portion 22 of the connection component 20.

The second main surface 42s2 (see FIG. 11) is a surface of the bus bar 42 directed in the −Z direction. The second main surface 42s2 is, for example, a flat surface provided in the horizontal direction. The second main surface 42s2 is a larger area than the side surface 42s3. For example, the second main surface 42s2 is exposed to the outside of the base plate 41S on the lower surface side (the second surface 51b side of the flat surface portion 51) of the base plate 41S (see FIG. 11). The second main surface 42s2 faces the heat transfer member 120 that will be described later. In the present embodiment, the second main surface 42s2 is in contact with the heat transfer member 120.

The side surface 42s3 is a surface of the bus bar 42 directed in the X direction or the Y direction. The side surface 42s3 is, for example, a flat surface provided in the Z direction. The side surface 42s3 couples the peripheral edge of the first main surface 42s1 and the peripheral edge of the second main surface 42s2. A boundary portion between the side surface 42s3 and the first main surface 42s1 may have roundness or inclination. Similarly, a boundary portion between the side surface 42s3 and the second main surface 42s2 may have roundness or inclination. The side surface 42s3 faces the inner surface 55s of the accommodation portion 55 in the X direction or the Y direction. The side surface 42s3 extends in parallel with the inner surface 55s of the accommodation portion 55.

The side surface 42s3 has, for example, a first side surface 45a, a second side surface 45b, a third side surface 45c, and a fourth side surface 45d. The first side surface 45a is located at the end of the bus bar 42 on the −X direction side (for example, the end of the horizontal plate portion 42p in the −X direction). The first side surface 45a is a flat surface provided in the Y direction and the Z direction. The second side surface 45b is located at an end of the bus bar 42 on the +X direction side (for example, the end of the horizontal plate portion 42p in the +X direction). The second side surface 45b is a flat surface provided in the Y direction and the Z direction. The third side surface 45c is located at the end of the bus bar 42 on the −Y direction side (for example, end of the horizontal plate portion 42p in the −Y direction). The third side surface 45c is a flat surface provided in the X direction and the Z direction. The fourth side surface 45d is located at the end of the bus bar 42 on the +Y direction side (for example, the end of the horizontal plate portion 42p in the +Y direction). The fourth side surface 45d is a flat surface provided in the X direction and the Z direction.

### 4.3.3 Holding Structure of Bus Bar

Next, a holding structure 80 that holds the bus bar 42 will be described.

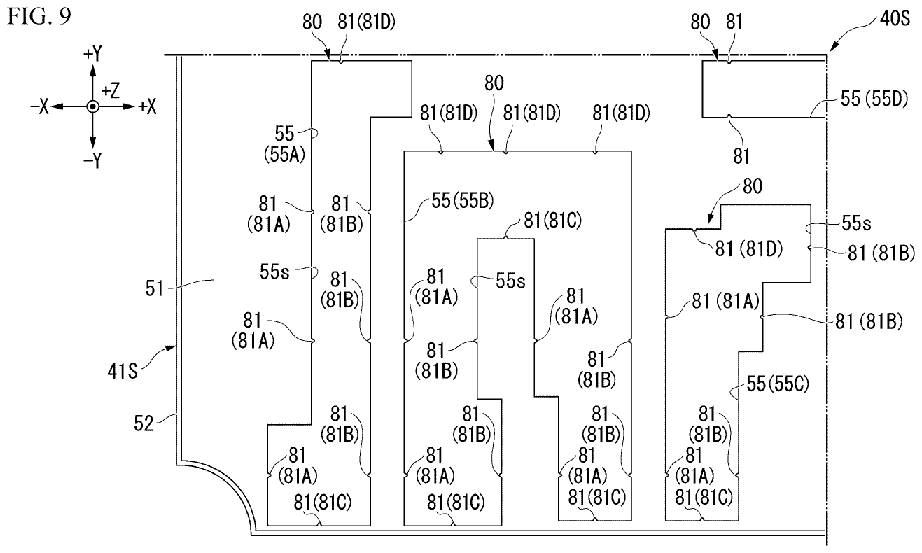

FIG. 9 is a plan view illustrating the base plate 41S. In the present embodiment, the holding structure 80 is provided as a part of the base plate 41S. The holding structure 80 has a plurality of protrusions 81 holding the bus bar 42. The plurality of protrusions 81 protrude from the inner surface 55s of the accommodation portion 55 toward the side surface 42s3 of the bus bar 42 (see FIG. 8). The plurality of protrusions 81 are in contact with the side surface 42s3 of the bus bar 42. The plurality of protrusions 81 hold the bus bar 42 with respect to the accommodation portion 55 in a state in which a gap g is formed between the inner surface 55s of the accommodation portion 55 and the bus bar 42.

A width W31 of the gap g in the direction in which the inner surface 55s of the accommodation portion 55 and the bus bar 42 are adjacent to each other is smaller than a thickness T1 (see FIG. 11) of the bus bar 42, for example. The width W31 is, for example, smaller than a thickness T11 (see FIG. 11) of the flat surface portion 51 of the base plate 41S.

In the present embodiment, the plurality of protrusions 81 are disposed to be arranged at intervals along the inner surface 55s of the accommodation portion 55 to surround the bus bar 42. The plurality of protrusions 81 include, for example, two or more protrusions 81 disposed to be arranged at intervals in the extending direction of the bus bar 42. The plurality of protrusions 81 are disposed to be arranged at intervals in the X direction or the Y direction, for example. The plurality of protrusions 81 protrude in the X direction or the Y direction from the inner surface 55s of the accommodation portion 55. The bus bar 42 is held by the plurality of protrusions 81, for example, by being press-fitted between the plurality of protrusions 81.

In the present embodiment, the plurality of protrusions 81 provided to correspond to one bus bar 42 include, for example, one or more first protrusions 81A, one or more second protrusions 81B, one or more third protrusions 81C, and one or more fourth protrusions 81D.

The first protrusion 81A is provided on the −X direction side with respect to the bus bar 42. The first protrusion 81A protrudes in the +X direction from the inner surface 55s of the accommodation portion 55 and is in contact with the side surface 42s3 of the bus bar 42. For example, one or more first protrusions 81A are in contact with the first side surface 45a of the bus bar 42.

The second protrusion 81B is provided on the +X direction side with respect to the bus bar 42. The second protrusion 81B protrudes in the −X direction from the inner surface 55s of the accommodation portion 55 and is in contact with the side surface 42s3 of the bus bar 42. For example, one or more second protrusions 81B are in contact with the second side surface 45b of the bus bar 42. The bus bar 42 is sandwiched from both sides in the X direction by the first protrusions 81A and the second protrusions 81B.

The third protrusion 81C is provided on the −Y direction side with respect to the bus bar 42. The third protrusion 81C protrudes in the +Y direction from the inner surface 55s of the accommodation portion 55 and is in contact with the side surface 42s3 of the bus bar 42. For example, one or more third protrusions 81C are in contact with the third side surface 45c of the bus bar 42.

The fourth protrusion 81D is provided on the +Y direction side with respect to the bus bar 42. The fourth protrusion 81D protrudes in the −Y direction from the inner surface 55s of the accommodation portion 55 and is in contact with the side surface 42s3 of the bus bar 42. For example, one or more fourth protrusions 81D are in contact with the fourth side surface 45d of the bus bar 42. The bus bar 42 is sandwiched from both sides in the Y direction by the third protrusions 81C and the fourth protrusions 81D.

### Disposition of Protrusions with Respect to Corner Portions of Bus Bar

In the present embodiment, the plurality of protrusions 81 are disposed to correspond to corner portions of the ends of the bus bars 42. The bus bar 42 has a first end 46 and a second end 47 as both ends of the bus bar 42 in the extending direction.

The first end 46 is formed by, for example, the first connection portion 61. The first end 46 has a corner 46c1 and a corner 46c2 as corners located at the ends of the bus bars 42B. The corner 46c1 is a corner on the −X direction side and on the −Y direction side. The corner 46c2 is a corner on the +X direction side and on the −Y direction side.

In the present embodiment, one first protrusion 81A, one second protrusion 81B, and one third protrusion 81C are provided to correspond to the first end 46 of the bus bar 42, and are in contact with the first end 46. The corner 46c1 is located between first protrusion 81A and third protrusion 81C in the direction along the side surface 42s3 of the bus bar 42. Similarly, the corner 46c2 is located between the second protrusion 81B and the third protrusion 81C in the direction along the side surface 42s3 of the bus bar 42. According to this constitution, the first end 46 is firmly supported by the three protrusions 81.

On the other hand, the second end 47 is an end opposite to the first end 46. The second end 47 is formed by, for example, the extension 64. However, the second end 47 may be formed by the connection portion 62. The second end 47 has a corner 47c1 and a corner 47c2 as corners located at the ends of the bus bars 42. The corner 47c1 is a corner on the −X direction side and on the −Y direction side. The corner 47c2 is a corner on the +X direction side and on the −Y direction side.

In the present embodiment, one first protrusion 81A, one second protrusion 81B, and one third protrusion 81C are provided to correspond to the second end 47 of the bus bar 42 and are in contact with the second end 47. The corner 47c1 is located between the first protrusion 81A and the third protrusion 81C in the direction along the side surface 42s3 of the bus bar 42. Similarly, the corner 47c2 is located between the second protrusion 81B and the third protrusion 81C in the direction along the side surface 42s3 of the bus bar 42. According to this constitution, the second end 47 is firmly supported by the three protrusions 81.

In a case where the second end 47 is an end on the +Y direction side, the corner 47c1 is a corner on the −X direction side and on the +Y direction side. The corner 47c2 is a corner on the +X direction side and on the +Y direction side. In this case, one first protrusion 81A, one second protrusion 81B, and one fourth protrusion 81D are provided to correspond to the second end 47 of the bus bar 42, and are in contact with the second end 47. The corner 47c1 is located between the first protrusion 81A and the fourth protrusion 81D in the direction along the side surface 42s3 of the bus bar 42. Similarly, the corner 47c2 is located between the second protrusion 81B and the fourth protrusion 81D in the direction along the side surface 42s3 of the bus bar 42. According to this constitution, the second end 47 is firmly supported by the three protrusions 81.

### Shape of Protrusion

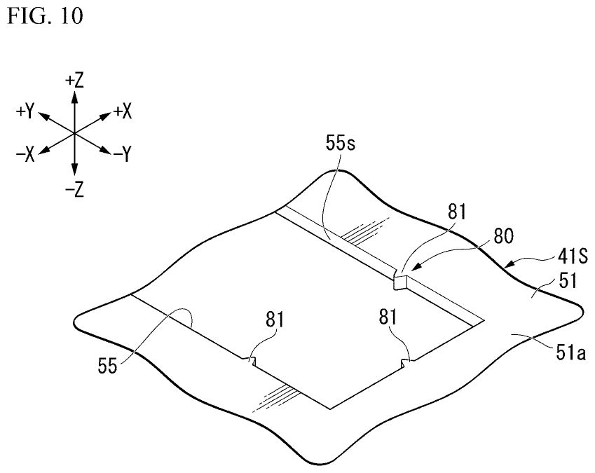

FIG. 10 is a perspective view showing the holding structure 80. In the present embodiment, the protrusion 81 has a shape in which the width in the horizontal direction intersecting the protruding direction decreases (tapers) as it advances in the direction protruding from the inner surface 55s of the accommodation portion 55.

### 4.3.4 Fastening Member

Next, the fastening member 43 will be described.

FIG. 11 is a cross-sectional view taken along line F11-F11 of the structure illustrated in FIG. 7. The fastening member 43 is a component for fixing the bus bar 42 to the connection component 20 corresponding to the bus bar 42. The fastening member 43 is, for example, a caulking bolt fixed to the bus bar 42. The fastening member 43 is an example of a “fastening portion”.

In the present embodiment, at least one of the connection portion 61 and the connection portion 62 of the bus bar 42 has a through-hole 42h. The through-hole 42h penetrates the bus bar 42 in the Z direction. The fastening member 43 is, for example, a bolt having a shaft 43a and a head 43b. A circumferential surface of the shaft 43a has a screw groove. The head 43b has a diameter larger than that of the shaft 43a. The head 43b of the fastening member 43 is caulked and fixed to the bus bar 42 in a state in which the shaft 43a passes through the through-hole 42h of the bus bar 42. With this fixation, the fastening member 43 is electrically and physically connected to the bus bar 42 in a state in which the shaft 43a protrudes in the +Z direction from the through-hole 42h of the bus bar 42. The fastening member 43 is not limited to caulking fixation, and may be fixed to the bus bar 42 through welding or other methods.

In the present embodiment, the connection component 20 is attached to the fastening member 43 from the Z direction in a state of being previously fixed to the electronic component 10 via the fastening member 71. For example, in the connection component 20, the shaft 43a of the fastening member 43 is inserted into the second attachment hole 22h of the second portion 22. The engagement member 44 (for example, a nut) is engaged with the shaft 43a of the fastening member 43 protruding from the second attachment hole 22h of the second portion 22 of the connection component 20. The engagement member 44 is attached to the shaft 43a in the Z direction. This engagement fixes the second portion 22 of the connection component 20 to the fastening member 43.

### Heat Transfer Member

Next, the heat transfer member 120 will be described. The heat transfer member 120 is a member for transferring heat generated by the electronic component 10 (for example, the electronic component 10S) at the time of energization and/or heat (Joule heat) generated by the bus bar 42 itself at the time of energization to the metal plate 110. The heat transfer member 120 is, for example, a heat transfer sheet (for example, a thermally conductive silicone sheet) having elasticity. The heat transfer member 120 is made of a material having a higher thermal conductivity than the base plate 41S, for example. However, the heat transfer member 120 is not limited to the above example, and may be a heat transfer member formed of a thermally conductive gel or another material. In the present embodiment, the heat transfer member 120 has an insulating property.

In the present embodiment, the heat transfer member 120 is partially provided in the routing board 40S (see FIG. 2). For example, the heat transfer member 120 is disposed at a position overlapping a part of the bus bar 42 when viewed from the Z direction. The heat transfer member 120 is disposed between the bus bar 42 and a flat surface portion 111 of the metal plate 110 that will be described later. For example, the heat transfer member 120 is disposed between the exposed portion 42u of the bus bar 42 and the flat surface portion 111 of the metal plate 110, and is in contact with the exposed portion 42u of the bus bar 42 and the flat surface portion 111 of the metal plate 110. The heat transfer member 120 transfers heat transferred from the electronic component 10 (for example, the electronic component 10S) to the bus bar 42 and/or heat generated by the bus bar 42 from the bus bar 42 to the flat surface portion 111 of the metal plate 110.

In the present embodiment, the heat transfer member 120 is disposed at a position overlapping a part of the bus bar 42 in the vicinity of the electronic component 10 (for example, the electronic component 10S) when viewed from the Z direction. In the present embodiment, the heat transfer member 120 is disposed at a position overlapping the connection component 20 when viewed from the Z direction. In other words, the heat transfer member 120 is disposed at a position overlapping the connection portion 61 or the connection portion 62 of the bus bar 42 when viewed from the Z direction. The heat transfer member 120 transfers heat transferred from the electronic component 10S to the bus bar 42 via the connection component 20 from the bus bar 42 to the flat surface portion 111 of the metal plate 110.

### 4.4 Fixing Structure of Routing Board and Electronic Component

Next, a fixing structure of the routing board 40S and the electronic component 10 will be described.

FIG. 9 is a cross-sectional view taken along line F9-F9 of the structure illustrated in FIG. 7. The metal plate 110 includes, for example, a fixing portion 112 and a fixing portion 113 in addition to a flat surface portion 111 that will be described later.

The fixing portion 112 is a fixing portion for fixing the base plate 41S to the metal plate 110. The fixing portion 112 is provided at a position corresponding to the fixing portion 53 of the base plate 41S when viewed from the Z direction. The fixing portion 112 is a cylindrical or prismatic boss protruding in the +Z direction from the flat surface portion 111 of the metal plate 110. The fixing portion 112 has an engagement hole 112h that is open in the +Z direction. An inner circumferential surface of the engagement hole 112h has a screw groove.

As described above, the fixing portion 53 of the base plate 41S has an attachment hole 53h. A fastening member 115 (for example, a screw or a bolt) passes through the attachment hole 53h. When the fastening member 115 that has passed through the attachment hole 53h of the fixing portion 53 of the base plate 41S is engaged with the engagement hole 112h of the fixing portion 112 of the metal plate 110, the base plate 41S is fixed to the metal plate 110.

The fixing portion 113 is a fixing portion for directly fixing the electronic component 10 (for example, the electronic component 10S) to the metal plate 110 without the base plate 41S interposed therebetween. The fixing portion 113 is provided at a position corresponding to the attachment portion 14 of the electronic component 10 when viewed from the Z direction. The fixing portion 113 is a cylindrical or prismatic boss protruding in the +Z direction from the flat surface portion 111. The fixing portion 113 has an engagement hole 113h that is open in the +Z direction. An inner circumferential surface of the engagement hole 113h has a screw groove.

In the present embodiment, the flat surface portion 51 of the base plate 41S has a through-hole 51h. The through-hole 51h penetrates the flat surface portion 51 in the Z direction. The through-hole 51h is provided at a position corresponding to the fixing portion 113 of the metal plate 110 when viewed from the Z direction. The fixing portion 113 of the metal plate 110 passes through the through-hole 51h of the base plate 41S and protrudes to the same position as the first surface 51a of the flat surface portion 51 or further toward the +Z direction side than the first surface 51a of the flat surface portion 51. The attachment portion 14 of the electronic component 10 is in contact with the fixing portion 113 at the same position as the first surface 51a of the flat surface portion 51 or at a position located further toward the +Z direction side than the first surface 51a of the flat surface portion 51.

A fastening member 116 (for example, a screw or a bolt) passes through the attachment hole 14h of the attachment portion 14 of the electronic component 10 from the +Z direction side. When the fastening member 116 that has passed through the attachment hole 14h of the attachment portion 14 of the electronic component 10 is engaged with the engagement hole 113h of the fixing portion 113 of the metal plate 110, the electronic component 10 is fixed to the metal plate 110 without the base plate 41S interposed therebetween. Note that, instead of the above-described example, the electronic component 10 may be fixed to a fixing portion provided in the base plate 41S.

### 5. Shape Example of Bus Bar

Next, a shape example of the bus bar 42 will be described.

Returning to FIG. 8, an example of the shape of the bus bar 42 will be described. The extending portion 63 of the bus bar 42A includes a first straight portion 63a extending in the Y direction from the connection portion 61 of the bus bar 42A and a second straight portion 63b bent from the first straight portion 63a and extending in the X direction.

A width W11 of the connection portion 61 of the bus bar 42A in the X direction is larger than a width W12 of the extending portion 63 of the bus bar 42A in the X direction (for example, the width W12 of the first straight portion 63a in the X direction). In the present embodiment, the connection portion 61 and the first straight portion 63a of the extending portion 63 are accommodated in the accommodation portion 55. Inside the accommodation portion 55, the width W11 of the connection portion 61 of the bus bar 42A in the X direction is larger than the width W12 of the extending portion 63 of the bus bar 42A in the X direction. The width W11 is, for example, the minimum width of the connection portion 61 in the X direction. The width W12 is, for example, the minimum width of the extending portion 63 in the X direction (for example, the minimum width of the first straight portion 63a in the X direction).

In the present embodiment, the width W12 (for example, the width W12 of the first straight portion 63a in the X direction) of the extending portion 63 of the bus bar 42A in the X direction is equal to or smaller than a width W13 (see FIG. 7) of the connection component 20A in the X direction. On the other hand, the width W11 of the connection portion 61 in the X direction is larger than the width W13 of the connection component 20A in the X direction. The width W13 is, for example, the minimum width of the connection component 20A in the X direction.

In the present embodiment, the extending portion 63 of the bus bar 42B includes a first straight portion 63a extending in the Y direction from the connection portion 61 of the bus bar 42B and a second straight portion 63b bent from the first straight portion 63a and extending in the X direction.

In the present embodiment, a width W21 of the connection portion 61 of the bus bar 42B in the X direction is larger than a width W22 of the extending portion 63 of the bus bar 42B in the X direction (for example, the width W22 of the first straight portion 63a in the X direction). In the present embodiment, the connection portion 61 and the first straight portion 63a of the extending portion 63 are accommodated in the accommodation portion 55. Inside the accommodation portion 55, the width W21 of the connection portion 61 of the bus bar 42B in the X direction is larger than the width W22 of the extending portion 63 of the bus bar 42B in the X direction. The width W21 is, for example, the minimum width of the connection portion 61 in the X direction. The width W22 is, for example, the minimum width of the extending portion 63 in the X direction (for example, the minimum width of the first straight portion 63a in the X direction).

In the present embodiment, the connection portion 61 of the bus bar 42B and the connection portion 61 of the bus bar 42A are adjacent to each other in the X direction. The first straight portion 63a of the extending portion 63 of the bus bar 42A and the first straight portion 63a of the extending portion 63 of the bus bar 42B are adjacent to each other in the X direction. In the present embodiment, the connection portion 61 of the bus bar 42A protrudes to the side opposite to the bus bar 42B (−X direction side) with respect to the first straight portion 63a of the extending portion 63 of the bus bar 42A. On the other hand, the connection portion 61 of the bus bar 42B protrudes to the side opposite to the bus bar 42A (+X direction side) with respect to the first straight portion 63a of the extending portion 63 of the bus bar 42B.

### 6. Metal Plate and Insulating Cover

Next, referring to FIG. 2 again, the metal plate 110 and the insulating cover 130 will be described.

### 6.1 Metal Plate

The metal plate 110 is a member that secures rigidity of the electrical connection unit 1 and enhances the heat dissipation property of the electrical connection unit 1. The metal plate 110 is made of metal (for example, aluminum or an aluminum alloy). The metal plate 110 is an example of a “rigid member”. The metal plate 110 may be referred to as a “metal member”or a “heat dissipation member”.

The metal plate 110 has a rectangular shape formed in the X direction and the Y direction. The metal plate 110 has a first end 110e1, a second end 110e2, a third end 110e3, and a fourth end 110e4. The first end 110e1 and the second end 110e2 are a pair of ends of the metal plate 110 in the longitudinal direction, and are separated in the X direction. The third end 110e3 and the fourth end 110e4 are a pair of ends of the metal plate 110 in the lateral direction, and are separated in the Y direction. The metal plate 110 includes, for example, the flat surface portion 111, the plurality of fixing portions 112 (see FIG. 12) described above, and the plurality of fixing portions 113 (see FIG. 12) described above.

The flat surface portion 111 is a portion formed in a plate shape in the metal plate 110. The flat surface portion 111 has a plate shape formed in the horizontal direction. The flat surface portion 111 forms a main portion of the metal plate 110. The flat surface portion 111 forms a base portion (metal base portion) of the metal plate 110. The flat surface portion 111 has a size that covers the two subunits SU from below.

In the present embodiment, the flat surface portion 111 has a first region A1 and a second region A2. The first region A1 is, for example, a region on the −Y direction side in the flat surface portion 111. The subunit SUS described above faces the first region A1 of the flat surface portion 111 when viewed from the Z direction. That is, the electronic component 10S and the base plate 41S included in the subunit SUS face the first region A1 of the flat surface portion 111 in the Z direction.

The second region A2 is, for example, a region on the +Y direction side in the flat surface portion 111. The above-described subunit SUT faces the second region A2 of the flat surface portion 111 when viewed from the Z direction. That is, the electronic component 10T and the base member 41T included in the subunit SUT face the second region A2 of the flat surface portion 111 in the Z direction.

### 6.2 Insulating Cover

The insulating cover 130 is a member for preventing a user's finger from contacting the energization path of the subunit SU. The insulating cover 130 is made of, for example, a synthetic resin and has an insulating property. The insulating cover 130 has, for example, a box shape that is open on the −Z direction side. The insulating cover 130 has a plurality of vent holes 130h. The insulating cover 130 covers a part or the whole of the corresponding subunit SU. Note that the insulating cover 130 is not limited to a box-shaped member, and may be a sheet-shaped member that covers the energization path of the main body MU. The insulating cover 130 may be omitted.

### 7. Advantages

As a comparative example, a constitution in which there is no gap between the inner surface 55s of the accommodation portion 55 and the bus bar 42, and the base plate 41S and the bus bar 42 are in close contact with each other will be considered. Here, the linear expansion coefficient of the base plate 41S made of a synthetic resin is larger than the linear expansion coefficient of the bus bar 42 made of metal. Therefore, in a case where the temperature of the electrical connection unit 1 is high, the base plate 41S tends to expand more than the bus bar 42. In a case where the temperature of the electrical connection unit 1 is low, the base plate 41S tends to shrink more than the bus bars 42. Therefore, in the constitution of the comparative example, it may be difficult to improve durability against a thermal shock.

On the other hand, the electrical connection unit 1 of the present embodiment includes the bus bar 42 and the insulating base plate 41S. The base plate 41S has the accommodation portion 55 in which at least a part of the bus bar 42 is accommodated. The electrical connection unit 1 is provided with a holding structure 80. The holding structure 80 has a plurality of protrusions 81 protruding from the inner surface 55s of the accommodation portion 55 toward the bus bar 42. The holding structure 80 holds the bus bar 42 with respect to the accommodation portion 55 in a state in which the gap g is formed between the inner surface 55s of the accommodation portion 55 and the bus bar 42.

According to such a constitution, since the contact area between the base plate 41S and the bus bars 42 is limited compared with the constitution of the above-described comparative example, a large stress is less likely to occur between the base plate 41S and the bus bars 42 at the time of thermal expansion/thermal contraction of the electrical connection unit 1. Since the gap g exists between the inner surface 55s of the accommodation portion 55 and the bus bar 42, a part of the shape change that occurs in the base plate 41S or the bus bar 42 at the time of thermal expansion/thermal contraction of the electrical connection unit 1 is absorbed by the gap g. Also from this viewpoint, a large stress is less likely to occur between the base plate 41S and the bus bars 42. For these reasons, according to the above constitution, durability against a thermal shock can be improved.

In the present embodiment, the plurality of protrusions 81 include two or more protrusions 81 disposed to be arranged at intervals in the extending direction of the bus bar 42. According to such a constitution, a plurality of locations of the bus bar 42 in the extending direction are held by the protrusions 81. According to this constitution, the shape of the base plate 41S or the bus bar 42 is likely to change in the extending direction of the bus bar 42. When the shape of the base plate 41S or the bus bar 42 is likely to change in the extending direction of the bus bar 42, it is possible to further suppress the occurrence of a large stress between the base plate 41S and the bus bar 42 at the time of thermal expansion/thermal contraction of the electrical connection unit 1. Through this operation, durability against a thermal shock can be further improved.

In the present embodiment, the base plate 41S has a plate-shaped flat surface portion 51. In a case where the thickness direction of the flat surface portion 51 is a first direction, the accommodation portion 55 is formed by the flat surface portion 51 being recessed in the first direction or the flat surface portion 51 being penetrated in the first direction. According to such a constitution, in a constitution in which the accommodation portion 55 is provided in the plate-shaped flat surface portion 51, it is possible to suppress the occurrence of a large stress between the base plate 41S and the bus bar 42.

In the present embodiment, in a case where the direction intersecting the first direction is a second direction, a plurality of protrusions 81 include a protrusion 81 protruding in the second direction. According to such a constitution, the bus bar 42 is held by the protrusion 81 protruding in the direction intersecting the thickness direction of the flat surface portion 51. With this constitution, in the constitution in which the accommodation portion 55 is provided in the plate-shaped flat surface portion 51, the bus bar 42 can be easily held with respect to the accommodation portion 55 in a state in which the gap g is formed between the inner surface 55s of the accommodation portion 55 and the bus bar 42.

In the present embodiment, the plurality of protrusions 81 include the first protrusion 81A provided on the −X direction side, the second protrusion 81B provided on the +X direction side, the third protrusion 81C provided on the −Y direction side, and the fourth protrusion 81D provided on the +Y direction side with respect to the bus bar 42. According to such a constitution, the bus bar 42 can be held from four directions by the first to fourth protrusions 81A, 81B, 81C, and 81D. With this constitution, bus bar 42 can be firmly held by the plurality of protrusions 81.

### 8. Modification Examples

Next, some modification examples of the above-described embodiment will be described. Note that a constitution other than that described below in each modification example is the same as the constitution of the above-described embodiment.

### First Modification Example

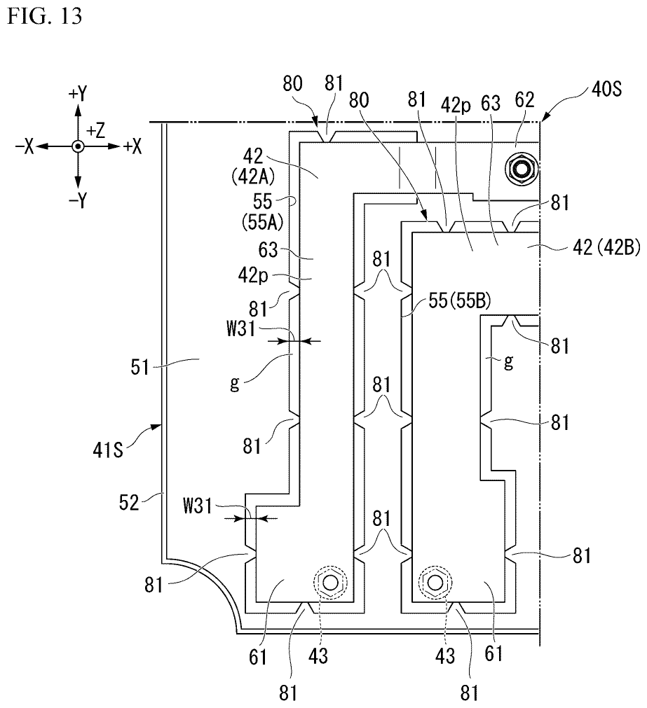

FIG. 13 is a plan view illustrating a routing board 40S of a first modification example. In the present modification example, the width W31 of the gap g is relatively large. For example, the width W31 of the gap g is larger than the thickness T11 (see FIG. 11) of the flat surface portion 51 of the base plate 41S.

Here, when the electronic component 10 generates heat, the heat may be confined in the gap S1 (see FIG. 11) between the flat surface portion 51 of the base plate 41S and the flat surface portion 111 of the metal plate 110. In the present modification example, since the gap g has the relatively large width W31, the gap g easily functions as a vent port for heat dissipation. That is, the air warmed in the gap S1 between the flat surface portion 51 of the base plate 41S and the flat surface portion 111 of the metal plate 110 easily moves as an upward flow to the upper surface side of the base plate 41S through the gap g.

According to such a constitution, in addition to the effects of the above embodiment, it is possible to further improve the heat dissipation property of the electrical connection unit 1.

### Second Modification Example

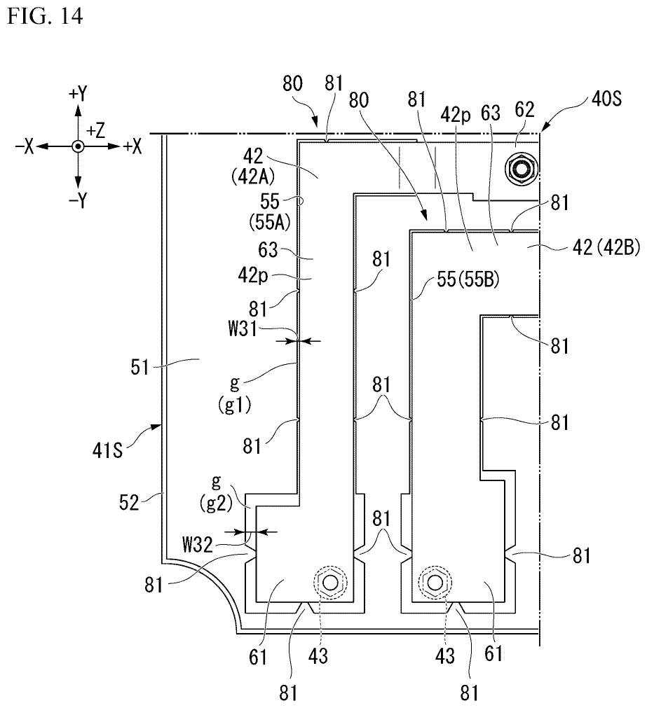

FIG. 14 is a plan view illustrating a routing board 40S of a second modification example. As described above, the connection portion 61 of the bus bar 42 is connected to the terminal 13 of the electronic component 10 via the connection component 20. Therefore, the connection portion 61 tends to have a higher temperature than the extending portion 63.

In the present modification example, the gap g includes a gap g1 and a gap g2. The gap g1 is formed between the inner surface 55s of the accommodation portion 55 and the extending portion 63 of the bus bar 42. On the other hand, the gap g2 is formed between the inner surface 55s of the accommodation portion 55 and the connection portion 61 of the bus bar 42.

In the present modification example, a width W32 of the gap g2 is larger than a width W31 of the gap g1. The width W31 of the gap g1 is a width of the gap g1 in a direction in which the inner surface 55s of the accommodation portion 55 and the bus bar 42 are adjacent to each other. The width W32 of the gap g2 is a width of the gap g2 in a direction in which the inner surface 55s of the accommodation portion 55 and the bus bar 42 are adjacent to each other. In the present modification example, the gap g2 that easily functions as a heat dissipation vent port is provided near the connection portion 61 that is likely to have a high temperature. That is, near the connection portion 61, the air warmed in the gap S1 between the flat surface portion 51 of the base plate 41S and the flat surface portion 111 of the metal plate 110 easily moves as an upward flow to the upper surface side of the base plate 41S through the gap g2.

According to such a constitution, in addition to the effects of the above embodiment, it is easy to improve the heat dissipation property of the electrical connection unit 1 as in the first modification example. In the present embodiment, the width W31 of the gap g1 is smaller than the width W32 of the gap g2. In other words, the protrusion 81 that supports the extending portion 63 of the bus bar 42 is smaller than the protrusion 81 that supports the connection portion 61 of the bus bar 42 and is less likely to bend. That is, in the present modification example, the bus bar 42 is supported by the relatively small protrusion 81 (the protrusion 81 that is not easily deflected) corresponding to the extending portion 63, and is hardly detached from the holding structure 80. Through this operation, the electrical connection unit 1 of the present modification example can further improve the durability.

### Third Modification Example

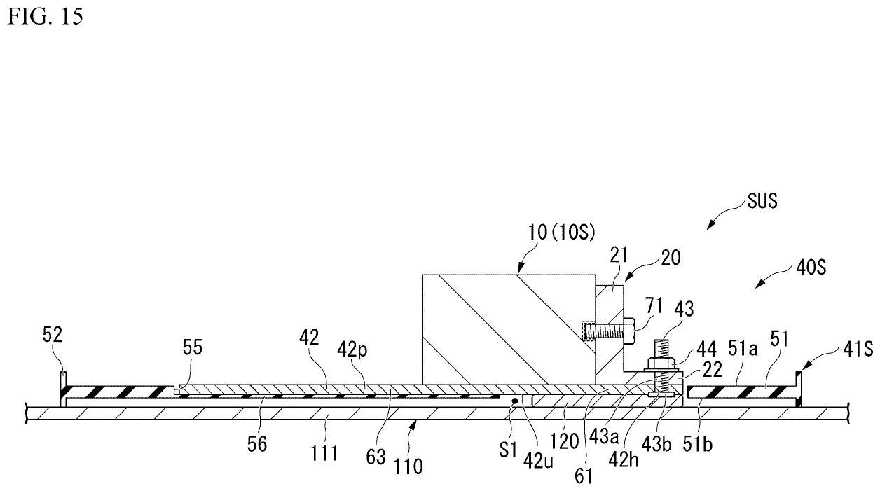

FIG. 15 is a cross-sectional view illustrating a subunit SUS of a third modification example. In the present modification example, the base plate 41S includes a support portion 56. The support portion 56 supports the horizontal plate portion 42p of the bus bar 42 accommodated in the accommodation portion 55 from below (−Z direction side). For example, the support portion 56 is provided to avoid a region overlapping the heat transfer member 120 when viewed from the Z direction.

Here, in a case where the electrical connection unit 1 is in an excessively high temperature state or an excessively low temperature state, it is conceivable that the base plate 41S or the bus bar 42 is excessively greatly deformed, and the bus bar 42 is about to fall off from the holding structure 80. However, in the present modification example, since the bus bar 42 is supported from below by the support portion 56, the bus bar 42 is more reliably prevented from falling off from the holding structure 80. Through this operation, the electrical connection unit 1 of the present modification example can further improve the durability.

### Fourth Modification Example

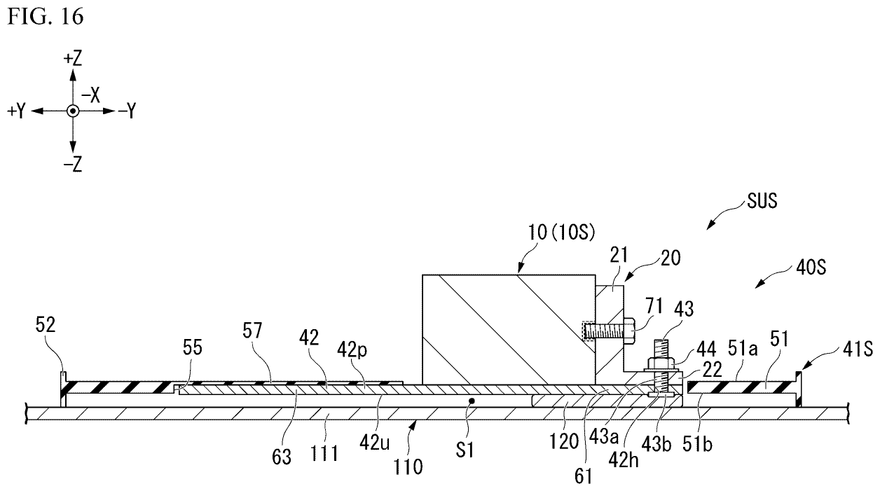

FIG. 16 is a cross-sectional view illustrating a subunit SUS of a fourth modification example. In the present modification example, the base plate 41S includes a support portion 57. The support portion 57 supports the horizontal plate portion 42p of the bus bar 42 accommodated in the accommodation portion 55 from above (+Z direction side). That is, the support portion 57 supports the bus bar 42 from the side opposite to the heat transfer member 120 having elasticity. The support portion 57 is provided to avoid, for example, a region overlapping the electronic component 10 when viewed from the Z direction.

According to such a constitution, since the bus bar 42 is supported from above by the support portion 57, the bus bar 42 is easily pressed toward the heat transfer member 120 having elasticity with a strong force compared with a case where the bus bar 42 is supported only by a plurality of protrusions 81. When the bus bar 42 can be pressed toward the heat transfer member 120 with a strong force, the heat transfer member 120 is more appropriately elastically deformed, and the heat transfer member 120 is easily brought into close contact with the bus bar 42 or the metal plate 110. When the heat transfer member 120 can be brought into close contact with the bus bar 42 or the metal plate 110, the heat dissipation property of the electrical connection unit 1 can be further improved.

### Fifth Modification Example

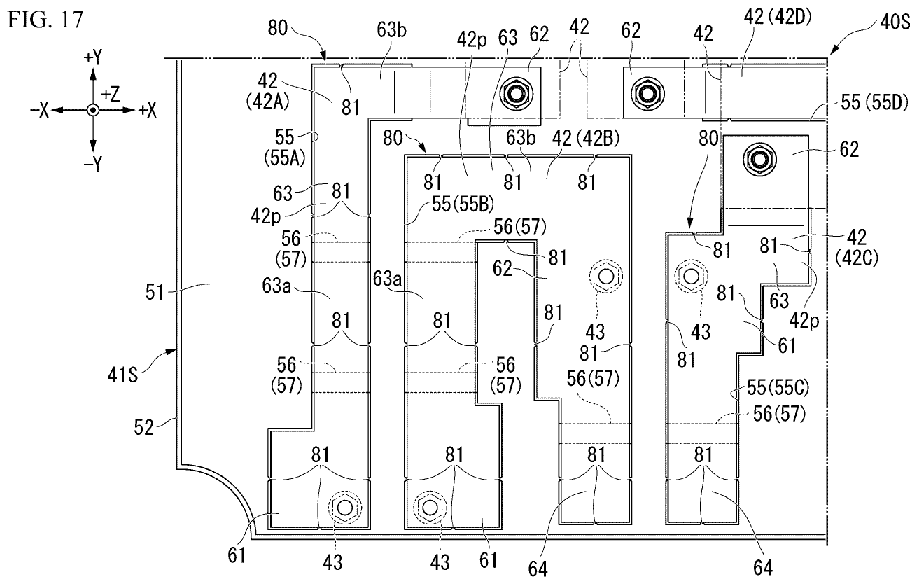

FIG. 17 is a plan view illustrating a routing board 40S of a fifth modification example. In the present modification example, a plurality of the support portions 56 described in the third modification example (or the support portions 57 described in the fourth modification example) are provided at a plurality of locations away from each other in the extending direction of the bus bar 42. Between the plurality of support portions 56, the bus bar 42 is exposed below the base plate 41S. Similarly, the bus bar 42 is exposed above the base plate 41S between the plurality of support portions 57. According to such a constitution, even when the support portion 56 (or the support portion 57) is provided, an exposed area of the bus bar 42 can be increased. When the exposed area of the bus bar 42 can be increased, the heat dissipation property of the electrical connection unit 1 can be further improved.

### Sixth Modification Example

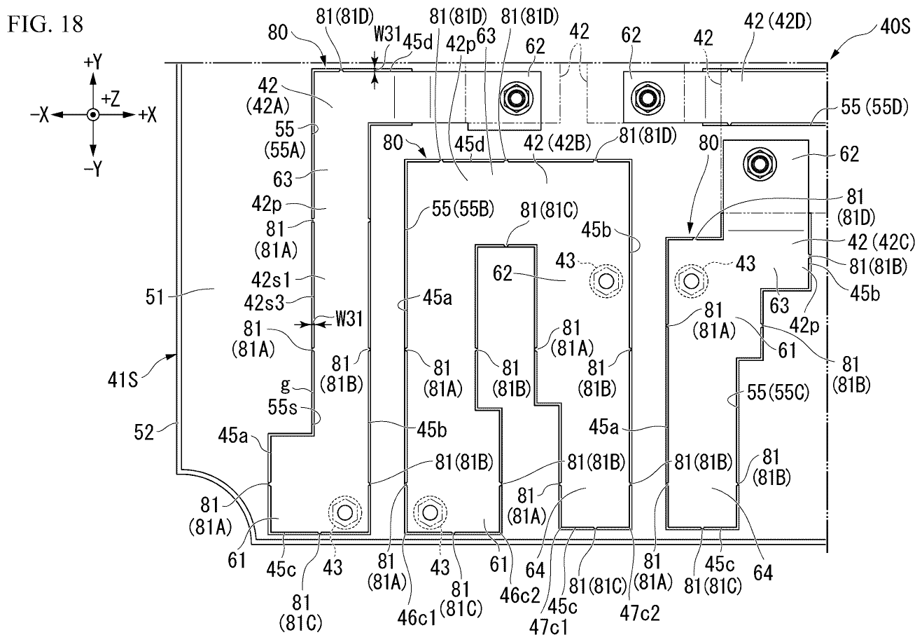

FIG. 18 is a plan view illustrating a routing board 40S of a sixth modification example. In the present modification example, instead of the plurality of protrusions 81 protruding from the inner surface 55s of the accommodation portion 55 toward the bus bar 42, the holding structure 80 includes a plurality of protrusions 81 protruding from the surface (for example, the side surface 42s3) of the bus bar 42 toward the inner surface 55s of the accommodation portion 55.

In the present modification example, the holding structure 80 is provided at the bus bar 42. For example, the holding structure 80 is integrally formed with the bus bar 42 as one piece member through press working or the like. The holding structure 80 has a plurality of protrusions 81 holding the bus bar 42 with respect to the inner surface 55s of the accommodation portion 55. The plurality of protrusions 81 protrude from the side surface 42s3 of the bus bar 42 toward the inner surface 55s of the accommodation portion 55. The plurality of protrusions 81 are in contact with the inner surface 55s of the accommodation portion 55. The plurality of protrusions 81 hold the bus bar 42 with respect to the accommodation portion 55 in a state in which a gap g is formed between the inner surface 55s of the accommodation portion 55 and the bus bar 42.

In the present embodiment, the plurality of protrusions 81 are disposed to be arranged at intervals along the inner surface 55s of the accommodation portion 55. The plurality of protrusions 81 include, for example, two or more protrusions 81 disposed to be arranged at intervals in the extending direction of the bus bar 42. The plurality of protrusions 81 are disposed to be arranged at intervals in the X direction or the Y direction, for example. The plurality of protrusions 81 protrude in the X direction or the Y direction from the side surface 42s3 of the bus bar 42.

In the present embodiment, the plurality of protrusions 81 provided at one bus bar 42 include, for example, one or more first protrusions 81A, one or more second protrusions 81B, one or more third protrusions 81C, and one or more fourth protrusions 81D.

The first protrusion 81A is provided on the −X direction side with respect to the bus bar 42. The first protrusion 81A protrudes in the −X direction from the side surface 42s3 of the bus bar 42 and is in contact with the inner surface 55s of the accommodation portion 55. For example, one or more first protrusions 81A protrude from first side surface 45a of the bus bar 42.

The second protrusion 81B is provided on the +X direction side with respect to the bus bar 42. The second protrusion 81B protrudes in the +X direction from the side surface 42s3 of the bus bar 42 and is in contact with the inner surface 55s of the accommodation portion 55. For example, one or more second protrusions 81B protrude from second side surface 45b of the bus bar 42. The bus bar 42 is sandwiched from both sides in the X direction by the first protrusions 81A and the second protrusions 81B.

The third protrusion 81C is provided on the −Y direction side with respect to the bus bar 42. The third protrusion 81C protrudes in the −Y direction from the side surface 42s3 of the bus bar 42 and is in contact with the inner surface 55s of the accommodation portion 55. For example, one or more third protrusions 81C protrude from third side surface 45c of the bus bar 42.

The fourth protrusion 81D is provided on the +Y direction side with respect to the bus bar 42. The fourth protrusion 81D protrudes in the +Y direction from the side surface 42s3 of the bus bar 42 and is in contact with the inner surface 55s of the accommodation portion 55. For example, one or more fourth protrusions 81D protrude from fourth side surface 45d of the bus bar 42. The bus bar 42 is sandwiched from both sides in the Y direction by the third protrusions 81C and the fourth protrusions 81D.

### Shape of Protrusion

In the present modification example, the protrusion 81 has a shape in which the width in the horizontal direction intersecting the protruding direction decreases (tapers) as it advances in the direction protruding from the surface of the bus bar 42.

Even with such a constitution, the same effects as those of the first embodiment can be obtained. The holding structure 80 may have both of a plurality of protrusions 81 protruding from the inner surface 55s of the accommodation portion 55 toward the bus bar 42 and a plurality of protrusions 81 protruding from the surface of the bus bar 42 toward the inner surface 55s of the accommodation portion 55.

Several embodiments and modification examples have been described above. However, the embodiment and the modification examples are not limited to the examples described above. For example, the plurality of modification examples described above may be implemented in combination with each other. For example, a connection between the electronic component 10 and the bus bar 42 is not limited to the connection using the connection component 20. The electronic component 10 may be directly connected to the bus bar 42 by using a fastening member (for example, a bolt or a screw), welding, or the like.

### REFERENCE SIGNS LIST

1 Electrical connection unit
SU, SUS, SUT Subunit
10, 10S, 10T Electronic component
13, 13A, 13B Terminal
20 Connection component
40S Routing board
40T Routing structure
41S Base plate
42 Bus bar
51 Flat surface portion
52 Frame portion
55 Accommodation portion
55s Inner surface of the accommodation portion
61 Connection portion
62 Connection portion
63 Extending portion
63a First straight portion
63b Second straight portion
80 Holding structure
81 Protrusion
81A First protrusion
81B Second protrusion
81C Third protrusion
81D Fourth protrusion
110 Metal plate (rigid member, metal member, heat dissipation member)
111 Flat surface portion
120 Heat transfer member

What is claimed is:

1. An electrical connection unit comprising:
a bus bar;
an insulating base member having an accommodation portion in which at least a part of the bus bar is accommodated; and
a holding structure including at least either of a plurality of protrusions protruding from an inner surface of the accommodation portion toward the bus bar and a plurality of protrusions protruding from a surface of the bus bar toward the inner surface of the accommodation portion, the holding structure holding the bus bar with respect to the accommodation portion in a state in which a gap is formed between the inner surface of the accommodation portion and the bus bar.

2. The electrical connection unit according to claim 1, wherein
at least either of the plurality of protrusions protruding from the inner surface of the accommodation portion and the plurality of protrusions protruding from the surface of the bus bar include two or more protrusions disposed to be arranged at intervals in an extending direction of the bus bar.

3. The electrical connection unit according to claim 1, wherein
the base member has a plate-shaped flat surface portion, and
in a case where a thickness direction of the flat surface portion is a first direction,
the accommodation portion is formed by the flat surface portion being recessed in the first direction or the flat surface portion being penetrated in the first direction.

4. The electrical connection unit according to claim 3, wherein
in a case where a direction intersecting with the first direction is a second direction,
at least either of the plurality of protrusions protruding from the inner surface of the accommodation portion and the plurality of protrusions protruding from the surface of the bus bar include a protrusion protruding in the second direction.

5. The electrical connection unit according to claim 1, wherein
the bus bar includes a plate portion accommodated in the accommodation portion, and
in a case where a thickness direction of the plate portion is a first direction, a direction intersecting the first direction is a second direction, and a direction intersecting the first direction and the second direction is a third direction,
at least either of the plurality of protrusions protruding from the inner surface of the accommodation portion and the plurality of protrusions protruding from the surface of the bus bar include, with respect to the bus bar, a first protrusion provided on one side in the second direction, a second protrusion provided on the other side in the second direction, a third protrusion provided on one side in the third direction, and a fourth protrusion provided on the other side in the third direction.
